(19) United States
(12) Patent Application Publication
(10) Pub. No.: US 2011/0187580 A1
(43) Pub. Date: Aug. 4, 2011

(54) DEVICE FOR DETECTING A VEHICLE ON AN AIRPORT RUNWAY

(76) Inventors: Guy Laenen, Westerlo (BE); Jean-Claude Vandevoorde, Steenkokkerzeel (BE); Geert Bollens, Boutersem (BE)

(21) Appl. No.: 12/682,503

(22) PCT Filed: Oct. 9, 2008
(86) PCT No.: PCT/EP2008/063537

§ 371 Date: Sep. 22, 2010

(30) Foreign Application Priority Data
Oct. 9, 2007 (DE) 10 2007 048 490.0

(51) Int. Cl. G01S 13/93

(52) U.S. Cl. 342/29

(57) ABSTRACT

The invention relates to a device (10) for detecting a vehicle, especially an aircraft (A), on an airport runway (R), especially a take-off or landing strip, a taxi strip or in the ramp region, said device comprising at least one radar sensor (11) which is arranged in the region of the runway (R) and used to scan a spatial detection region (E) by means of a radar beam. The fact that the detection region (E) comprises two lobe-shaped partial regions (E1, E2) extending horizontally over the runway (R) and transversally to the direction of travel (V) of the vehicle (A), and the radar sensor (11) is designed to scan the detection region (E) by means of microwaves, enables vehicles moving on runways to be detected with higher measuring precision, higher sensor reliability and using a robust measuring principle.

The invention relates to a device for detecting a vehicle, particularly an aircraft, on the runway of an airport, particularly on a take-off or landing runway, on a taxi runway or in the ramp region, having at least one radar sensor arranged in the region of the runway that is configured with a radar beam for scanning a spatial detection field.

The world-wide increase of air traffic is facing airports having limited taxi runways for processing take-offs and landings of aircraft. The expansion of operating times and new construction or renovations of airports cannot keep up with increasing air traffic. The consequences are increasing take-off and landing cycles, and denser traffic on the take-off and landing runways, on taxi runways, on the pre-runways, and in the region between the gates of the airports. Aircraft, particularly aircraft of different types, as well as ground vehicles, such as tankers, shuttle buses, luggage carts, supply vehicles for ground power and catering, mobile aircraft ramps and the like, share the runways of an airport.

Due to the high traffic volume vehicles increasingly impede each other, leading to unintentional incidents, such as the unnecessary blocking of a take-off or landing runway, or even to collisions resulting in significant vehicle damage or even personal injury. The holding positions in front of junctions or intersections of a runway leading to a take-off or landing runway, the following of vehicles in multi-lane pre-runway regions, and generally the region between terminals pose critical traffic situations. Incidents limit the availability of the runways, and thus the capacity of an airport, which impedes air traffic overall more than reducing the traffic density thereof.

A plurality of systems for monitoring and controlling airport traffic is known. The air traffic control personnel in the traffic control tower is responsible for the aircraft movement in close range to the airport, including the runways of the airport. In addition to the verbal radio communication to the vehicles involved in the traffic, a central operating and monitoring unit having screens and input devices are available to the air traffic control personnel. The air traffic control personnel receives information from detection devices via the screen for detecting aircraft, while lighting systems for emitting light signals or illuminated warnings signs for the pilots are operated via the input devices.

Multilateration systems are known for detecting aircraft, wherein the position of an aircraft is calculated from the operating time differences of a signal sent from an aircraft to three or more sensors being arranged on the airport grounds in a distributed manner. The positioning of aircraft by means of ground radar having a rotating antenna is also known. For this purpose reference is made to patent application DE 103 06 922 A1, wherein a system for monitoring airport grounds is known, wherein aircraft are positioned by means of a plurality of radar sensors. The grounds detection using conventional rotating antennas is simulated in that a plurality of antenna elements attached to a curved carrier is actuated using transmission signals successively in a chronological manner.

Said detection devices have large detection fields, which extent over the entire airport grounds and beyond. They have chronological detection gaps due to latency periods of the sensor system, but also spatial detection gaps in the form of shaded areas; detection errors, such as ghost or phantom images, also occur. Furthermore, such detection devices are costly both in terms of acquisition and operation.

Local detection devices are also known, the detection ranges of which are smaller and in direct sensor approximation. Microwave barriers are known, the transmitter and receiver of which are arranged on opposite sides of a runway, and which detect an aircraft when the same shadows the receiver from the transmitter during the penetration of the detection field. Such detection devices are very sensitive to weather.

The translation DE 37 52 132 T2 of the European Patent Specification EP 0 317 630 B1 discloses a device for guiding an aircraft on the ground. Aircraft detection signals are always emitted in an overlapping state by two sensors corresponding to adjacent induction loops, whereby a vehicle may be continuously detected. In case of a motor vehicle the signals do not overlap such that the same may be differentiated from aircraft. However, induction loops are extremely susceptible to maintenance and also extensive in their maintenance due to the installation thereof in a runway.

A device for guiding aircraft on runways is known from patent application DE 199 49 737 A1, wherein at least one radar sensor is provided for aircraft monitoring. The radar sensor is configured as a Doppler radar in order to monitor the movement of the aircraft via the frequency difference. Preferably, multiple sensors are distributed across the length of the runway in order to enable complete monitoring. Two radar sensors are integrated into each below or above ground light, the radiation lobes of which extend laterally from the bottom to the top in two opposite directions.

The invention is based on the object of further improving a detection device of the above mentioned type such that the detection of vehicles moving on runways is enabled at a greater measurement accuracy, higher sensor reliability, and using a robust measuring principle.

The problem is solved according to the invention by means of a generic detection device having the features of the characteristic part of claim 1. Accordingly, the detection field has two lobe-shaped partial fields extending horizontally over the runway and transverse to the driving direction of the vehicle. In this manner a geometry of the detection field is created, which allows simple determination of the presence and of movement variables of a passing vehicle, particularly an aircraft, that is free of any time delays. By configuring the radar sensor for scanning the detection field using microwaves, a measuring principle having high accuracy and robustness can be utilized.

In an advantageous embodiment of the detection device according to the invention the at least one radar sensor has a double-beam configuration and the two partial fields of the detection field are oriented relative to each other at a divergence angle in a horizontal plane. In this manner a compact embodiment is provided, which is of advantage for the on-the-field use on airports having high wind forces from time to time. A double-beam radar sensor gives lower dispersion values for the signal/noise ratio in a noisy measurement. Due to an asymmetry of the respective standardized curves of both light paths scanning the partial fields, advantageously fewer similar angular patters are created such that the measurement dispersions have less of an influence. This results in fewer erroneous angle associations. As an alternative, the two partial fields may also be scanned by two single-beam radar sensors.

In a preferred embodiment of the detection device according to the invention the radar sensor is configured for scanning its detection field by means of the frequency modulated continuous wave method. Accordingly, the radar sensor transmits continuously, but at a continuously changing frequency in the saw tooth pattern, or with linear, alternatingly increasing and decreasing frequency, such that the distance of the vehicle to the sensor in addition to the speed thereof can be determined.

In an advantageous embodiment, the detection device according to the invention has a control unit for analyzing detection signals supplied by the radar sensor. By means of computing and memory means of the control unit, sensor signals supplied to it may be processed utilizing stored analysis algorithms without any time delay, in order to immediately recognize whether a vehicle is located within the detection field at all, and if this is the case, in order to derive usable detection results with regard to a vehicle state and type identification.

Preferably, the control unit of the detection device according to the invention is configured for determining a position and/or a speed and/or an acceleration and/or a length and/or a type of the vehicle. By the comparison to the reference patterns and values deposited in the memory means of the analysis unit a plurality of aircraft and other ground vehicle types, including the position or location and state of movement thereof, may be detected.

In a preferred embodiment the control unit of the detection device according to the invention is connected to a central operation and monitoring unit via a communication interface for bidirectional data exchange. The communication interface may be configured as a wire-bound field bus having a local communication unit and a communication line, but may also be configured as a wireless local data network. Therethrough, the control unit may transmit notifications on sensor analyses to the air traffic control personnel or to a central operation and monitoring unit, such as to an air traffic control tower of the airport, but also to further control units of other detection devices.

In a further preferred embodiment the control unit of the detection device according to the invention is connected via the communication interface to a lighting unit for actuation thereof, the lighting unit being arranged on the runway following the detection field of the radar sensor in the driving direction, and being configured for emitting a light signal to a vehicle detected by the radar sensor. If the lighting device is configured for emitting a stop or guidance signal, it may be actuated, for example, by means of the control unit, when the control unit detects a vehicle having no clearance to proceed, or which is driving at too high of a speed, or which has distanced itself sideways too far from the runway center line. The actuation of the lighting unit may be carried out subject to confirmation by the operation and monitoring unit.

In a further preferred embodiment the detection device according to the invention comprises a housing accommodating the at least one radar sensor, which has a region permeable to microwaves. The radar sensor is protected from climatic influences by the housing. The same may be made from aluminum pressure diecast or plastic, but must have a region through which the transmission rays and the reflected echo rays can pass.

Preferably, the housing of the detection device according to the invention is arranged sideways to the runway above pavement level, and is fastened by means of a ground fixture having a point of weakness (i.e. being frangible). In this manner it is ensured that the obstacle resistance provided by the detection device to a vehicle running off the runway, is predetermined, and not too high. However, it is also conceivable to arrange the housing embedded in the runway below pavement level.

In a further advantageous embodiment the radar sensor of the detection device according to the invention is integrated into the housing of an in-pavement or above-pavement light. By integrating the sensor into a light unit, standardized components can be used and energy supply units, control units and communication units of lighting systems can be utilized advantageously.

Further properties and advantages of the detection device according to the invention are obvious from the following description of the drawings, in which

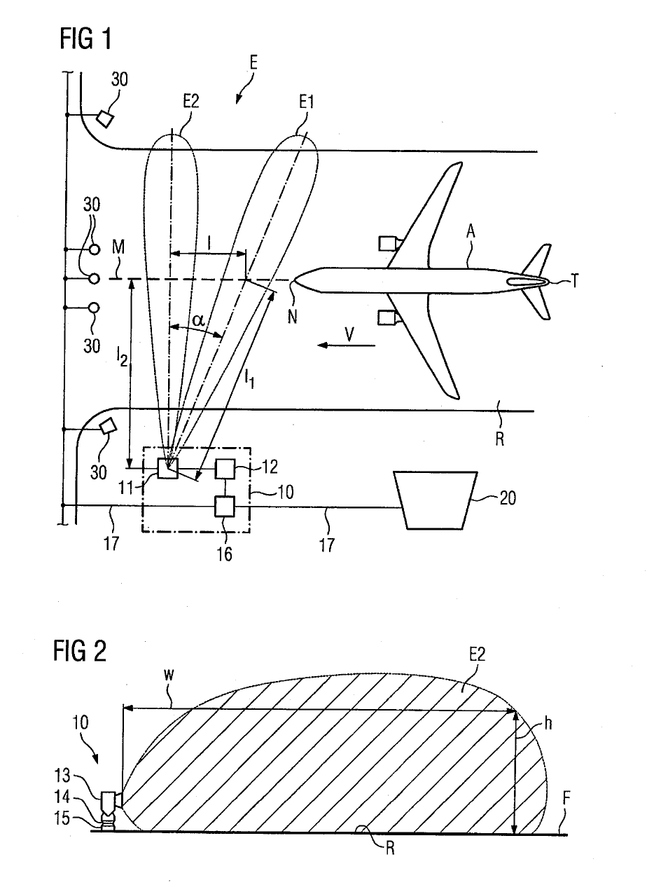

FIG. 1 a top view of a detection device arranged on a runway,

FIG. 2 a cross-section across the detection field of a radar sensor,

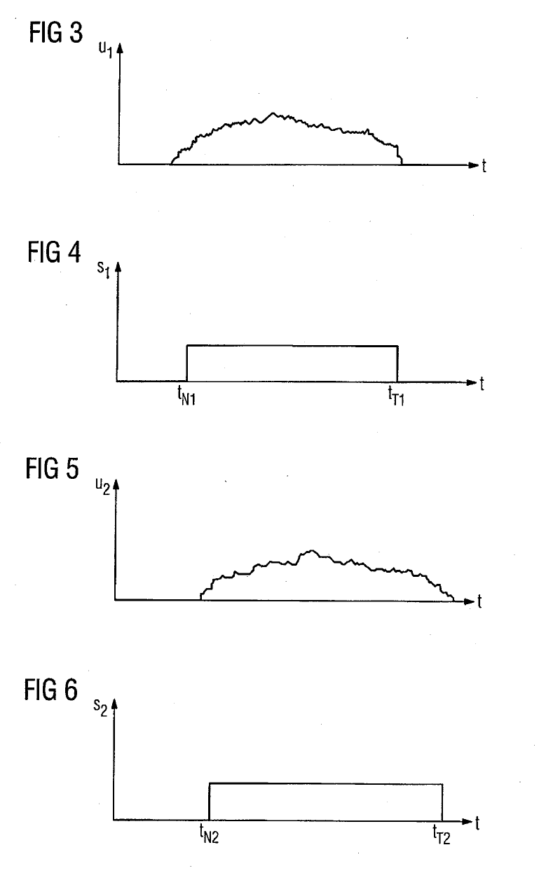

FIG. 3 a chronological course of a signal amplitude associated with a first partial field of the detection field,

FIG. 4 a chronological course of an antenna signal associated with the first partial field of the detection field,

FIG. 5 a chronological course of a signal amplitude associated with a second partial field of the detection field,

FIG. 6 a chronological course of antenna signal associated with the second partial field of the detection field

are shown schematically.

FIG. 1 shows an aircraft A taxiing on a runway R of an airport. The runway R is, for example, a taxi runway of a width of about 30 m, which meets a take-off and landing strip in the driving direction V of the aircraft A. On taxi runways aircraft typically move at a speed of 30 km/h to 80 km/h, moving along at approximately the centerline M thereof at that speed. In order to monitor the traffic taxiing toward the take-off or landing strip a device 10 according to the invention for the detection of vehicles moving on the runway R is provided.

For this purpose the detection device 10 has a two-beam radar sensor 11, which is arranged, for example, at a distance of about 10 m transverse to the edge of the taxi runway. The radar sensor 11 scans a detection field E, which has two lobe-shaped partial fields E1 or E2. The beam axes of the associated radar beams are denoted in FIG. 1 by means of semicolon lines. Each partial field E1 or E2 extends horizontally and transverse to the driving direction V of the aircraft A across the runway R. The beam axis of the second partial field E2 extends substantially perpendicular to the center line M, while the beam axis of the first partial field E1 is aligned at a—horizontal, e.g. positioned within the drawing plane—divergence angle α of preferably between 5° and 45°, particularly preferred between 10° and 20°, to the beam axis of the second partial field E2 in opposite direction of the driving direction V.

The radar beams scan the detection field E using microwave radiation, which supplies particularly accurate measuring values and allows the use of radar sensors having an excellent robustness. According to FIG. 2 the radar beams, such as the partial field E2 of the detection field E, have a detection range w of up to 100 m and a detection height h of at least 25 m above pavement level F of the runway R. For this purpose each of the partial fields E1 or E2 spans a planar detection area positioned perpendicularly on the runway R, which is enabled by means of the focused radar beam. For this purpose the radar sensor 11 may operate according to the frequency modulated continuous wave method.

According to FIG. 2 the detection device 10 has a housing 13, by means of which the radar sensor 11, not illustrated herein, is enclosed for the protection from climatic influences and flying debris. At the side thereof facing the runway R the housing 13 has a region that is transparent for microwaves, which allows the radar beams emitted by the sensor 11, and the echo beams reflected by the aircraft A to the sensor antenna to permeate. The housing 13 is arranged above pavement level F, and has an upper part that is configured tiltable and pivotable relative to a lower part. In this manner the radar beam may be aligned. The lower part has a mount 15 for mounting the housing 13 to the ground, which comprises a point of weakness 14 in the form of a cross-sectional constriction. Advantageously, the detection device 10 is integrated in an above-pavement light.

In order to analyze the scanning signals supplied by the radar sensor 11, the detection device 10 according to FIG. 1 comprises a local control unit 12 having computing and memory means (not illustrated) for electronic data processing. If the taxiing aircraft A penetrates the first and the second partial fields E1 respectively E2, voltage amplitudes u₁ or u₂ are generated in the sensor antenna, the chronological courses of which are illustrated in FIG. 3 and FIG. 5. Said sensor amplitudes u₁ or u₂ describe a signature of the detected aircraft A, from which respective antenna signals s₁ or s₂ are derived, the chronological courses of which are illustrated in FIG. 4 and FIG. 6. The time points t_{N1} and t_{N2} at which the nose N of the aircraft penetrates the partial field E1 resp. E2 are obtained from the antenna signals u₁ or u₂, and the times t_{T1} and t_{T2} at which the tail T of the aircraft penetrates the partial field E1 resp. E2.

In the control unit 12, upon penetration of the nose N of the aircraft through the partial fields E1 and E2, the distances I₁ resp. I₂ to the aircraft's nose N from the radar sensor 11 are now calculated from the frequency shift. In this manner it can be determined, whether the position of the aircraft A deviates transversely from the center line M of the runway R. Furthermore, by taking the angle α into account, it is possible to determine the path length l between the passage through the first and the second partial fields E1 resp. E2. The speed of the aircraft A is assumed as the mean value from the speeds of the nose N of the aircraft and the tail T of the aircraft. The speeds of the aircraft's A nose N and tail T results from the division of the path length l by the respective time differences (t_{N2}−t_{N1}) and (t_{T2}−t_{T1}) of the antenna signals s₁ and s₂ respectively. By comparing the two time differences, an acceleration or time delay of the aircraft A may be deduced. Furthermore, the aircraft length may be determined by multiplying the mean value from the time differences by the calculated speed. The aircraft length combined with the signature, e.g. the chronological course of the sensor amplitude, finally enables the determination of the aircraft type, that is to say of the vehicle type, since ground vehicles may also be differentiated from aircraft in this manner.

The plurality of information detected, in the simplest case the detection of the presence of an aircraft A within the detection field E, can now be transferred to the exterior via a communication interface that may comprise a communication unit 16 of the detection device 10 and a communication line 17. The communication interface is configured as a bidirectional field bus, to which a central operation and monitoring unit 20 for air traffic control personnel, such as in an air traffic control tower of an airport, and a lighting system30 are connected. The lighting system 30 is arranged after the detection device 10, directly in front of the junction of the taxi runway R to the take-off or landing strip and in the driving direction V of the aircraft A, and comprises two above-pavement lights installed sideways to the runway R and one transverse row of inset lights embedded centrally in the runway for sending stop signals to a pilot of the aircraft A. If, for example, the aircraft A has not observed an active stop position, the control unit 12 notifies the operation and monitoring unit 20 and the lighting system 30, via the communication interface 16 or 17, of the detection of the aircraft A. Subsequent to confirmation by the air traffic control personnel via the unit 20 the lighting system 30 is actuated in order to generate a stop signal. This serves for the visual signaling of the pilot so as to attempt to prevent the penetration of the aircraft A into the take-off or landing strip. In this regard, the detection device 10 according to the invention represents a safety function in airfield, monitoring systems.

1. A device for the detection of a vehicle, particularly of an aircraft, on a runway of an airport, particularly on a take-off or landing strip, on a taxi runway or on the ramp, having at least one radar sensor arranged in the field of the runway, that is configured with a radar beam for scanning a spatial detection field, wherein the detection field has two lobe-shaped partial fields extending horizontally over the runway and transverse to the driving direction of the vehicle, and that the radar sensor is configured for scanning the detection field using microwaves.

2. The detection device according to claim 1, wherein the at least one radar sensor has a double-beam configuration and wherein the two partial fields of the detection field are aligned relative to each at a divergence angle in a horizontal plane.

3. The detection device (10) according to claim 1, wherein the radar sensor is configured for scanning its detection field (E) by means of a frequency modulated continuous wave method.

4. The detection device according to claim 1, having a local control unit for analyzing scanning signals supplied by the radar sensor.

5. The detection device according to claim 4, wherein the control unit is configured for determining a position, a speed, an acceleration, a length and a type of vehicle.

6. The detection device according to claim 4, wherein the control unit is connected to a central operation and monitoring unit via a communication interface for bidirectional data exchange.

7. The detection device according to claim 4, wherein the control unit is connected via the communication interface to a lighting unit for actuation thereof, the lighting unit being arranged on the runway following the detection field of the radar sensor in the driving direction, and being configured for emitting a light signal to a vehicle detected by the radar sensor.

8. The detection device according to claim 1, having a housing accommodating the at least one radar sensor, which comprises a region that is permeable to microwaves.

9. The detection device according to claim 1, wherein the housing is arranged sideways to the runway above pavement level, and is fastened by means of a ground fixture having a point of weakness.

10. The detection device according to claim 9, wherein the radar sensor is integrated in the housing of an in-pavement or above-pavement light.
